(19) United States
(12) Patent Application Publication
(10) Pub. No.: US 2025/0278257 A1
(43) Pub. Date: Sep. 4, 2025

(54) ARTIFICIAL INTELLIGENCE AUTOMATED APPLICATION GENERATION

(71) Applicant: Toyota Motor North America, Inc., Plano, TX (US)

(72) Inventors: Simon P. ROBERTS, Celina, TX (US); Dineth KUMARASINGHE, Flower Mound, TX (US); William HARGIS, Celina, TX (US); David TSAI, Irvine, CA (US); Shravanthi DENTHUMDAS, Frisco, TX (US); Brian KURSAR, Fairview, TX (US)

(73) Assignees: Toyota Motor North America, Inc., Plano, TX (US); Toyota Jidosha Kabushiki Kaisha, Toyota-shi, Aichi-ken (JP)

(21) Appl. No.: 18/593,263

(22) Filed: Mar. 1, 2024

(51) Int. Cl. G06F 8/41; G06F 8/10; G06F 8/35; G06F 8/60; G06F 11/36

(52) U.S. Cl. CPC G06F 8/44; G06F 8/10; G06F 8/35; G06F 8/60; G06F 11/3616; G06F 11/3668

(57) ABSTRACT

Aspects of the present disclosure provide techniques for artificial intelligence (AI)-based software application generation. An example method includes obtaining a description of a software application. The method further includes providing, to an artificial intelligence (AI) model, first input data comprising an indication of the description. The method further includes obtaining, from the AI model, first output data comprising one or more first executable packages of the software application. The method further includes storing the one or more first executable packages in memory for execution by one or more processors.

### TECHNICAL FIELD

The present disclosure generally relates to software development, and more particularly, to automated application generation.

### BACKGROUND

Software development tools continue to evolve and are implemented in varying degrees to assist a software developer or software engineer. As an example, an integrated development environment (IDE) is a software application that provides comprehensive features for software development. IDEs provide a user interface that developers can use to develop software components and applications. IDEs generally include developer tools, such as a source code editor, syntax highlighting, code completion, a compiler and/or interpreter, a build- automation tool, and a debugger. IDEs may also include a version control system and other tools to simplify development certain features, such as a graphical user interface (“GUI”). Other software development tools include issue tracking systems, version control systems, automated testing suites, etc.

### SUMMARY

Some aspects provide a method. The method includes obtaining a description of a software application. The method further includes providing, to an artificial intelligence (AI) model, first input data comprising an indication of the description. The method further includes obtaining, from the AI model, first output data comprising one or more first executable packages of the software application. The method further includes storing the one or more first executable packages in memory for execution by one or more processors.

Some aspects provide a system. The system includes one or more memories. The system includes one or more processors coupled to the one or more memories. The one or more processors are configured to cause the system to obtain a description of a software application; provide, to an artificial intelligence (AI) model, first input data comprising an indication of the description; obtain, from the AI model, first output data comprising one or more first executable packages of the software application; and store the one or more first executable packages in the one or more memories for execution by at least one processor.

Some aspects provide a system. The system includes means for obtaining a description of a software application. The system further includes means for providing, to an artificial intelligence (AI) model, first input data comprising an indication of the description. The system further includes means for obtaining, from the AI model, first output data comprising one or more first executable packages of the software application. The system further includes means for storing the one or more first executable packages in memory for execution by one or more processors.

Some aspects provide a non-transitory computer-readable medium. The non-transitory computer-readable medium has instructions stored thereon for performing a method. The method includes obtaining a description of a software application. The method further includes providing, to an artificial intelligence (AI) model, first input data comprising an indication of the description. The method further includes obtaining, from the AI model, first output data comprising one or more first executable packages of the software application. The method further includes storing the one or more first executable packages in memory for execution by one or more processors.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an example system for artificial intelligence (AI) based software application generation;

FIG. 2 depicts an example architecture for AI-based software application generation;

FIG. 3 depicts an example system for developing and deploying a software application via an AI host;

FIG. 4 depicts an example neural network for software application generation;

FIG. 5 depicts an example architecture for training one or more AI models to generate an executable package based on a description of a software application;

FIG. 6 depicts example operations of AI-based software application generation; and

FIG. 7 depicts an example of a processing system that is configured to perform the operations described herein.

### DETAILED DESCRIPTION

Aspects of the present disclosure provide systems, methods, and computer-readable mediums for artificial intelligence (AI)-based application generation.

Software development can rely on various resources to develop a software application, such as personnel, time, and computing resources. As an example, a software application may be developed and maintained by several teams of software engineers, including separate teams for front-end development, back-end development, and/or cloud computing management. In some cases, a quality assurance team performs code review, testing, and/or maintaining automated testing suites. In certain cases, the software development process relies on the expertise of certain software engineers to develop specific features, such as compatibility with certain operating systems, user interface design, web application design, artificial intelligence features, etc. Thus, software development may rely on non-trivial amounts of expertise, time, and/or computing resources to develop a software application.

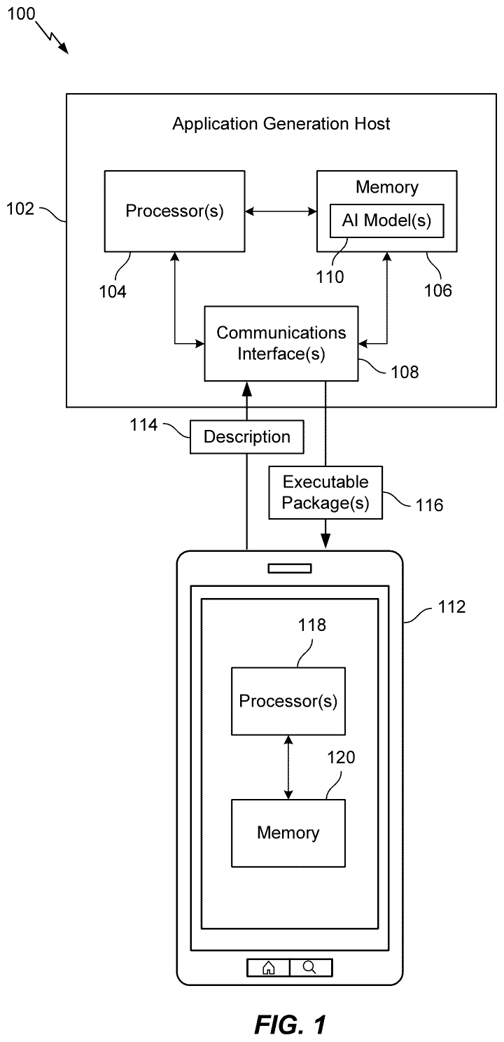

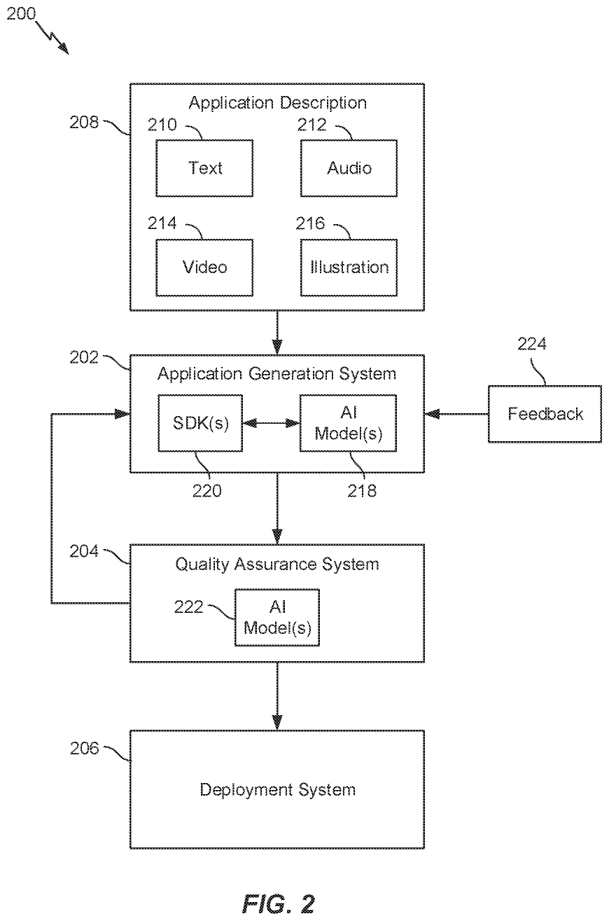

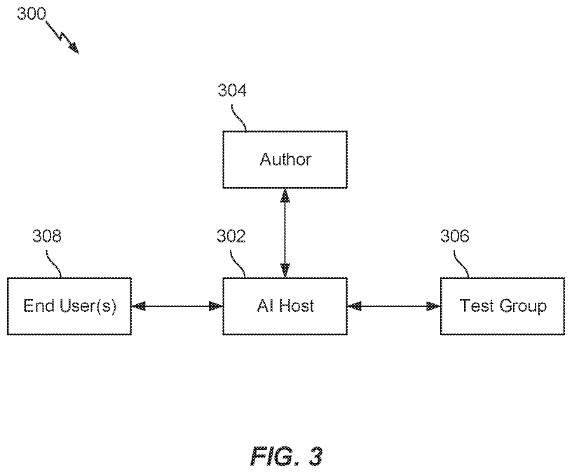

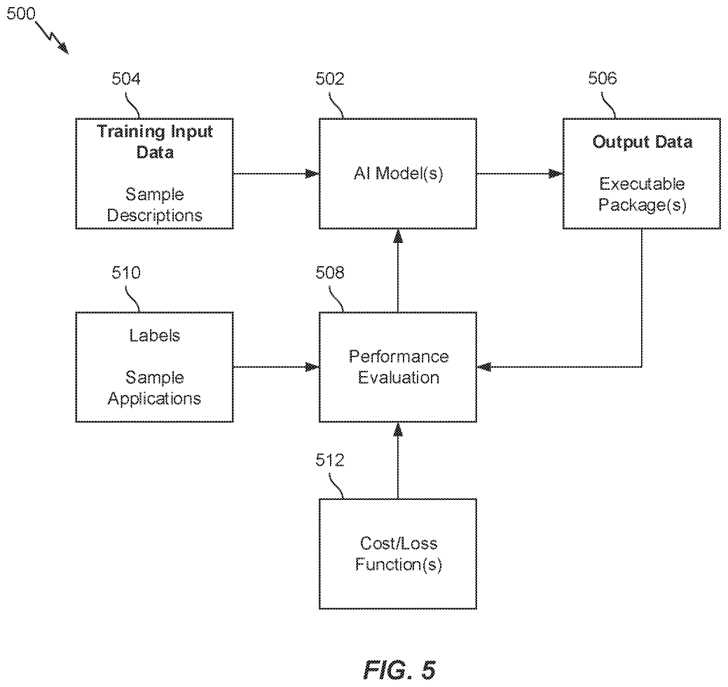

Aspects of the present disclosure provide techniques for AI-based software application generation. In certain cases, a generative AI system may produce a custom software application based on a description of the software application, for example, as further described herein with respect to FIG. 1. As an example, a user may provide a text description of the software to a generative AI system, and based on the description, the generative AI may output an application for the user, such that the application satisfies the user's description. In some cases, the generative AI system may generate a software application with a software development kit (SDK), as further described herein with respect to FIG. 2. In certain cases, the generative AI system may perform quality assurance tests on the AI generated software as further described with respect to FIG. 2. The generative AI system may allow collaboration among an author of the description and other individuals, such as a test group and/or end user. For example, the generative AI system may edit a software application based on feedback, for example, from the author of the description, one or more testers, or an end user of the software application, as further described herein with respect to FIG. 3. The generative AI system may include one or more generative AI models trained to output one or more executable packages of the described software application, as further described herein with respect to FIG. 5.

The techniques for AI-based software application generation described herein may provide any of various advantages and/or beneficial effects. The techniques for AI-based software application generation may enable a reduction in resources used to develop the software application. As an example, the AI-based software application generation system may be capable of generating a software application in less time and/or with fewer personnel. The AI-based software application generation system may enable users with little or no software development experience to generate a custom software application. The AI-based software application generation system may enable the development of niche or customized software that would otherwise go undeveloped, for example, due to the user base being too small or unprofitable.

### Example AI-Based Software Application Generation System

FIG. 1 depicts an example system 100 for AI-based software application generation. In this example, the system 100 includes an application generation host 102. The application generation host 102 may include one or more processors 104 (hereinafter “the processor 104”), one or more memories 106 (hereinafter “the memory 106”), and one or more communications interfaces 108 (hereinafter “the communications interface 108”). The processor 104 may be coupled to the memory 106 and the communications interface 108. In some cases, the memory 106 may be coupled to the communications interface 108.

The processor 104 may be or include any device capable of executing processor-readable instructions stored in the memory 106. As an example, the processor(s) 104 may be or include one or more of: a microcontroller, a microprocessor, an AI processor, a digital signal processor (DSP), a central processing unit (CPU), a graphics processing unit (GPU), a field programmable gate array (FPGA), a programmable logic device (PLD), a computer, or any other suitable computing device. The processor 104 may be configured to implement one or more AI models 110, for example, as further described herein with respect to FIG. 2. In certain aspects, the processor 104 may perform the techniques for AI-based application generation described herein.

The memory 106 may be include one or more non-transitory computer readable media. As an example, the memory 106 may be or include one or more of: random access memory (RAM), read-only memory (ROM), flash memory, a hard drive, or any non-transitory memory device capable of storing processor-executable instructions such that the instructions can be accessed and executed by the processor 104. The functionality described herein may be implemented in any computer programming language or object code, as pre-programmed hardware elements, or as a combination of hardware and software components.

The communications interface 108 may be configured to facilitate communications with one or more other devices, such as a computing device 112. As shown, the application generation host 102 is in communication with the computing device 112. In some cases, the communications interface 108 may be or include a network interface controller (e.g., an Ethernet controller or fiber optic transceiver) and/or a wireless communications interface (e.g., a radio frequency transceiver) configured to communicate with one or more other devices, for example, in a data network. As an example, the data network may include a private data network, a public data network (e.g., the internet), or a hybrid data network. In certain cases, the communications interface 108 may be or include an input/output interface (e.g., a universal serial bus) for communicating with auxiliary hardware.

The application generation host 102 receives a description 114 of a software application (or an indication thereof) from the computing device 112. The computing device 112 may send the description 114 to the application generation host 102 through a data network, such as the internet, interconnecting the application generation host 102 and the computing device 112. Based on the description 114, the application generation host 102 generates one or more executable package 116 (hereinafter “the executable package 116”) of the software application as further described herein with respect to FIG. 2, and the application generation host 102 sends the executable package 116 to the computing device 112. In some cases, the application generation host 102 may store the executable package 116 and/or information that can enable reproduction of the executable package 116 (e.g., the description 114 of the software application) in the memory 106. The executable package 116 (and/or information that can enable reproduction of the executable package 116) may be stored in the memory 106 to enable delayed deployment of the executable package 116, distribution of the executable package 116 to multiple devices, and/or editing of the software application via feedback, for example.

The description 114 may describe one or more features of the software application. As an example, the description 114 may describe that the application “provides personalized workout plans, tracks progress, and provides exercise tutorials for different fitness levels.” As another example, the description may be or include text that says “create a mobile app for managing personal finance and budgeting.” In certain aspects, the description 114 may include the functionality of the software application. In certain aspects, the description 114 may include the appearance of the software application, such as features of the user interface including theming, branding, color schemes, navigation, layout, input and output controls, etc. In certain aspects, the description 114 may include one or more end user of the software application, such as the target audience of the software, the characteristics of an end user including age, ethnicity, race, gender, etc. In certain aspects, the description 114 may include one or more operating platforms of the software application, such as the operating system and/or minimum hardware requirements for running the software application. As an example, an operating platform may indicate that the software application can run on Windows®, Linux®, MacOS®, iOS®, Android®, and/or as a web-application.

The computing device 112 may be or include a portable computing device (e.g., a smartphone, smart glasses, smart watch, cellular phone, etc.), a server, a computer (e.g., a laptop computer, a tablet computer, a personal computer (PC), a desktop computer, etc.), a virtual computing device, or any other electronic device or computing system capable of running the executable package 116 as described herein. The computing device 112 may include one or more processors 118 (hereinafter “the processor 118”) and one or more memories 120 (hereinafter “the memory 120”) coupled to the processor 118. The processor 104 and the memory 106 may be representative of the processor 118 and the memory 120, respectively. With respect to the computing device 112, the processor 118 run the executable package 116, which is stored in the memory 120. The executable package 116 may be or include one or more instructions that, when executed by the processor 118, cause the processor 118 to perform one or more actions of the software application in accordance with the description 114. As an example, the executable package 116 may implement a mobile application for managing personal finance and budgeting according to the description. In certain aspects, the application generation host 102 may be integrated with the computing device 112. For example, the computing device 112 may perform the AI-based application generation, as described herein, using at least the processor 118 and the memory 120.

In certain aspects, the software application may be or include a client-side web application. For example, the executable package 116 may be or include client-side software, such as one or more webpages comprising HyperText Markup Language (HTML), Cascading Style Sheets (CSS), and/or JavaScript. In certain aspects, the software application may be or include a server-side application. For example, the executable package 116 may be or include server-side software, such as a webserver for hosting webpages or a backend for processing client-side information. In certain aspects, the software application may be or include client-side and server-side software. For example, the executable package 116 may be or include the client-side software as described above, and a server (e.g., the application generation host 102) may host such client-side software.

FIG. 2 depicts an example architecture 200 for AI-based software application generation. In this example, the architecture 200 comprises an application generation system 202, a quality assurance (QA) system 204, and a deployment system 206. In certain aspects, the architecture 200 may be implemented by a processing system, such as the application generation host 102.

The application generation system 202 is configured to generate at least one executable package of a software application based at least on a description 208 of the software application, for example, as described herein with respect to FIG. 1. The application generation system 202 obtains the description 208, which may include a text description 210, an audio description 212, a video description 214, a visual illustration 216 of the software application, or any suitable format for the description 208. The application generation system 202 may provide input data to one or more AI models 218 (hereinafter “the AI model 218”). The input data may include the description 208 of the software application. Based on the input data, the AI model 218 provides output data including, for example, one or more executable packages (e.g., the executable package 116) of the software application. In some cases, the AI model 218 may generate an executable package using one or more software development kits 220 (SDKs) (hereinafter “the SDK 220”).

In certain aspects, to generate an executable package, the AI model 218 may use (or be trained based on) any of various tools of the SDK 220. In certain aspects, the SDK 220 may include code libraries that provide common functions and/or features, such as user interface controls, networking, and data storage. The SDK 220 may include debugging tools that provide tools or functions to find issues in the code and suggest fixes. The SDK 220 may include documentation or information on how to use the various components of the SDK. The SDK 220 may include an integrated development environments (IDE) that provides tools for writing, testing, and/or debugging code. The SDK 220 may include a testing framework or suite that automates the testing of code to ensure that the code works correctly or as expected. The SDK 220 may include one or more plug-ins that provide add-on features to certain development environments like Eclipse™, Visual Studio™, or Xcde®, such as adding support for a particular programming language, text editor, language translation, etc. The SDK 220 may include an application programming interface (API) that interacts with various features and services of an operation platform or programming language. The SDK 220 may include sample code that demonstrates how to use the APIs, libraries, or programming language provided in the SDK. Using the SDK 220 may allow the executable package of the software application satisfy certain specifications and/or expected results, such as the user interface appearance and/or the integration of services or features (e.g., integration with peripheral devices, satisfying device specifications, integration with device hardware, etc.).

In certain aspects, the application generation system 202 may include multiple AI models 218. The AI models 218 may be or include one or more of: a generative AI model, a transformer model, a generative pre-trained transformer (GPT) model, a machine learning (ML) model, a natural language processing (NLP) model, a deep learning model, a reinforcement learning model, a neural network, a decision tree, logistic regression, linear regression, etc. In some cases, the AI models 218 may have certain performance characteristics. Some of the AI models 218 may have different accuracies (e.g., classification accuracy and/or regression accuracy of the output data), different processing latencies (e.g., the computational time of an AI model), and/or different processing capacities (e.g., capabilities to perform parallel or concurrent processing of data). The application generation system 202 may select a particular AI model 218 that meets certain performance characteristics, which may depend on settings and/or input from a user.

In certain aspects, the AI models 218 may have certain input/output (I/O) schemes. Some of the AI models 218 may be trained to process certain input data, such as a description in one or more formats. For example, a first AI model may be trained to process the text description 210, whereas a second AI model may be trained to process the audio description 212. In some cases, an AI model may be trained to process descriptions in multiple formats. The application generation system 202 may select a particular AI model 218 that is capable of processing the format of the description 208 provided to the application generation system 202. In certain aspects, some of the AI models 218 may be trained to provide certain output data, such as an executable package that is compatible with one or more operating specifications and/or operating platforms. For example, a first AI model may be trained to output an executable package capable of running on iOS®, whereas a second AI model may be trained to output an executable package capable of running on Android®. In some cases, an AI model may be trained to output multiple types of output data, such as an executable package for each operating platform (e.g., iOS® and Android®). The application generation system 202 may select a particular AI model 218 that is capable of outputting an executable package in accordance with the operating specifications. Thus, the AI models 218 may process different description formats and/or output executable packages with different operating specifications.

In certain aspects, the application generation system 202 may use multiple AI models in a processing pipeline to generate the application software. As an example of a processing pipeline, a first AI model may convert an audio description to text; a second AI model may convert the text description into a classification of software components or a framework for the software application; a third AI model may convert the software components into source code; and a fourth AI model may transform the source code into one or more executable packages of the software application. In some cases, these various AI models may be integrated into an AI system, such as the application generation system 202.

The QA system 204 is configured to test the output data of the AI model 218. The QA system 204 may determine whether an executable package, which was output by the application generation system 202, satisfies one or more evaluation criteria. The evaluation criteria may include performance metrics (or indicators), such as the number of user interactions to accomplish a result, processing latency, memory usage, processor usage, storage size, etc. The evaluation criteria may include satisfying any or all of the features of the description. In some cases, the QA system 204 may run automated and/or pre-configured tests on the executable package. Through the testing, the QA system 204 may evaluate whether the executable package meets any or all of the features of the software application per the description 208. In certain aspects, if the QA system 204 identifies that an executable package does not satisfy certain criteria, the QA system 204 may provide a report to the application generation system 202. The application generation system 202 may obtain the report and output an updated executable package based on the report.

In certain aspects, the QA system 204 may include one or more AI models 222 (hereinafter “the AI model 222”) that evaluate the performance and/or quality of an executable package output by the application generation system 202. As an example, the AI model 222 may provide the report (e.g., a score or prediction) on the executable package satisfying the features of the description 208 and/or performance metrics. The AI model 222 may provide the report to the application generation system 202, which may update the executable package based on the report. Note that certain aspects of the AI model 218 may be representative of the AI model 222.

The deployment system 206 is configured to transfer the executable package to a computing device, such as the computing device 112. In certain aspects, the deployment system 206 may store and/or host the executable package, for example, as described herein with respect to FIG. 1.

In certain aspects, the application generation system 202 may obtain feedback 224 on an executable package generated via the AI model 218. Aspects of the description 208 may be representative of the feedback 224. As an example, in response to using the executable package, a user of the executable package may send the feedback 224 to the application generation system 202. Based on the feedback, the application generation system 202 may output an updated version of the executable package and send the updated version to the user. The user that provides the feedback 224 may be the author of the description 208, a test group, and/or the end user as further described herein with respect to FIG. 3.

FIG. 3 depicts an example system 300 for developing and deploying a software application via an AI host 302, such as the application generation host of FIG. 1. In this example, the AI host 302 obtains a description of a software application, for example, from an author 304. The author 304 may be or include one or more individuals that create the description. The AI host 302 generates one or more executable packages of the software application based on the description from the author 304, for example, as described herein with respect to FIGS. 1 and 2. The AI host 302 may transfer the executable packages to the author 304 and/or a test group 306, which may include one or more testers. The author 304 and/or the test group 306 may run the AI-generated software on a computing device (e.g., the computing device 112) and provide feedback on the AI generated software. The AI host 302 may generate an updated version of the software application based on the feedback. The author 304 and/or the test group 306 may repeat this process of testing the AI-generated software and providing feedback to the AI host until the AI-generated software is deemed satisfactory. At which point, the author 304 may allow one or more end users 308 to access the software generated using the AI host 302. In some cases, the author 304, the test group 306, and the end user 308 may be the same individual, such that the AI host 302 allows an individual with little or no software development expertise to create a custom software application.

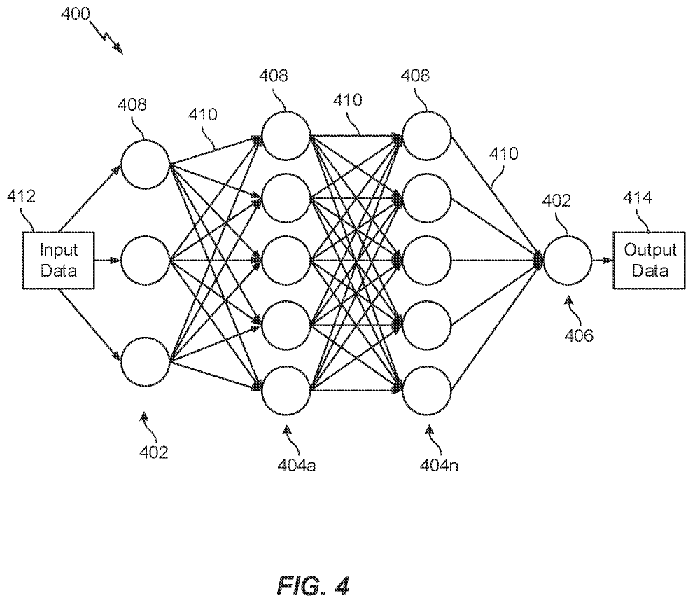

FIG. 4 depicts an example neural network 400 for software application

generation. In this example, the neural network 400 may include multiple layers 402, 404a, 404n, 406, having one or more nodes 408 (e.g., artificial neurons or perceptrons), connected by connection paths 410 (e.g., synapses). The neural network 400 includes at least an input layer 402 and an output layer 406. In some cases, the neural network 400 includes one or more hidden layers 404a-404n. The input layer 402 represents input data 412 that is fed into the neural network 400. For example, the input data 412 may include a description of the software application (e.g., the description 114). In some cases, the input data 412 may undergo pre-processing, such as normalization, segmentation, concatenation, etc. The input data 412 may be input into the neural network 400 at the input layer 402. The neural network 400 may process the input data 412 at the input layer 402 through the corresponding nodes 408 and/or connection paths 410. In certain aspects, each of the connection paths 410 may have a corresponding weight (e.g., a synaptic weight) that is applied to the value of a previous node to determine the value of a target node interconnected by the respective connection path 410.

In certain aspects, a node 408 may calculate its current value using synaptic weights of connection paths coupled to the node 408 and the previous layer and the output values of the nodes coupled to the connection paths. In some cases, the node 408 may calculated is current value using a summation of the weighted output values of all incoming connection paths 410 using the respective synaptic weights. In certain aspects, an activation function may be applied to the weighted sum calculated at any of the nodes. The result of the activation function may be the output value of the node. An activation function may be or include a rectifier activation function (e.g., a rectified linear unit (ReLU)), a sigmoid function, a hyperbolic tangent (tanh), for example.

The one or more hidden layers 404a-n, depending on the inputs from the input layer 402 and the weights on the connection paths 410, carry out computational activities. For example, each of the hidden layers 404a-n perform computations and transfer information from the input layer 402 to the output layer 406 through their associated nodes 408 and connection paths 410. The one or more hidden layer(s) 404a-n may feed into one or more nodes 408 of the output layer 406. There may be one or more output layers 406 depending on the configuration of the neural network 400. As an example, the neural network 400 may be trained to generate output data 414 including, for example, one or more executable packages of a software application.

In general, when a neural network is learning (or being trained), the neural network is identifying and determining patterns within the input data 412 received at the input layer 402. In response, one or more parameters, for example, weights associated to connection paths 410 between nodes 408, may be adjusted through a process known as back-propagation. Note that there are various processes in which learning may occur, however, two general learning processes include associative mapping and regularity detection. Associative mapping refers to a learning process where a neural network learns to produce a particular pattern on the set of inputs whenever another particular pattern is applied on the set of inputs. Regularity detection refers to a learning process where the neural network learns to respond to particular properties of the input patterns. Whereas in associative mapping the neural network stores the relationships among patterns, in regularity detection the response of each unit has a particular “meaning”. This type of learning mechanism may be used for feature discovery and knowledge representation.

Neural networks possess knowledge that is contained in the values of the synaptic weights. Modifying the knowledge stored in the network as a function of experience implies a learning rule for changing the values of the weights. Information may be stored in a weight matrix W of a neural network. Learning may involve determination and/or adjustment of one or more weights. Following the way learning is performed, two major categories of neural networks can be distinguished: a) fixed networks in which the weights cannot be changed (i.e., dW/dt=0) and a) adaptive networks which are able to change their weights (i.e., dW/dt not=0). In fixed networks, the weights are fixed a priori according to the problem to solve.

FIG. 5 depicts an example architecture 500 for training one or more AI models 502 (hereinafter “the AI model 502”) to generate an executable package based on a description of a software application. The AI model 502 may be an example of any of the AI models described herein, such as the AI model 218, the AI model 222, and/or the neural network 400.

In this example, the AI model 502 obtains training input data 504 and processes the training input data 504 to produce output data 506. At 508, an AI host (e.g., the application generation host 102) may evaluate the performance of the output data 506 and adjust the AI model 502 based on the respective performance. In some cases, the AI host may compare the output data 506 to one or more labels 510 corresponding to the training input data 504. The labels 510 may include the expected output of the AI model 502 for the training input data 504. The labels 510 may include software applications that correspond to the sample descriptions. The AI host may compare the output data 506 to one or more labels 510 using one or more loss or cost functions 512 (hereinafter “the cost function 512”). The cost function 512 may calculate or determine a difference between the output data and the corresponding label. In certain aspects, the cost function 512 may determine the difference between certain performance metrics of the generated executable packages and the expected output. In certain aspects, the cost function 512 may determine the interactions overtime of the generated executable packages and the expected interactions. In certain aspects,

As an example, in order to train a neural network (e.g., the neural network 400) to perform some task (e.g., generate an executable package), adjustments to the weights of the connection paths are made in such a way that an error (e.g., a cost or a loss) between the desired or expected output (e.g., the labels 510) and the actual output (e.g., the output data 506) is reduced. The error may be determined according to the cost function 512. This process may involve the neural network computing the error derivative of the weights (EW). In other words, the neural network may calculate how the error changes as each weight is increased or decreased slightly. A back-propagation algorithm is one method that is used for determining the EW.

The algorithm computes each EW by first computing the error derivative (EA), the rate at which the error changes as the activity level of a unit is changed. For output units, the EA is simply the difference between the actual and the desired output. To compute the EA for a hidden unit in the layer just before the output layer, first all the weights between that hidden unit and the output units to which it is connected are identified. Then, those weights are multiplied by the EAs of those output units and the products are added. This sum equals the EA for the chosen hidden unit. After calculating all the EAs in the hidden layer just before the output layer, in like fashion, the EAs for other layers may be computed, moving from layer to layer in a direction opposite to the way activities propagate through the neural network, hence “back propagation”. Once the EA has been computed for a unit, it is straight forward to compute the EW for each incoming connection of the unit. The EW is the product of the EA and the activity through the incoming connection. Note that this is only one method in which a neural network is trained to perform a task. In certain aspects, the AI model 502 may be trained using supervised learning and/or reinforcement learning. The AI model 502 may be trained via online training or via batched training methods.

### Example AI-Based Software Application Generation Operations

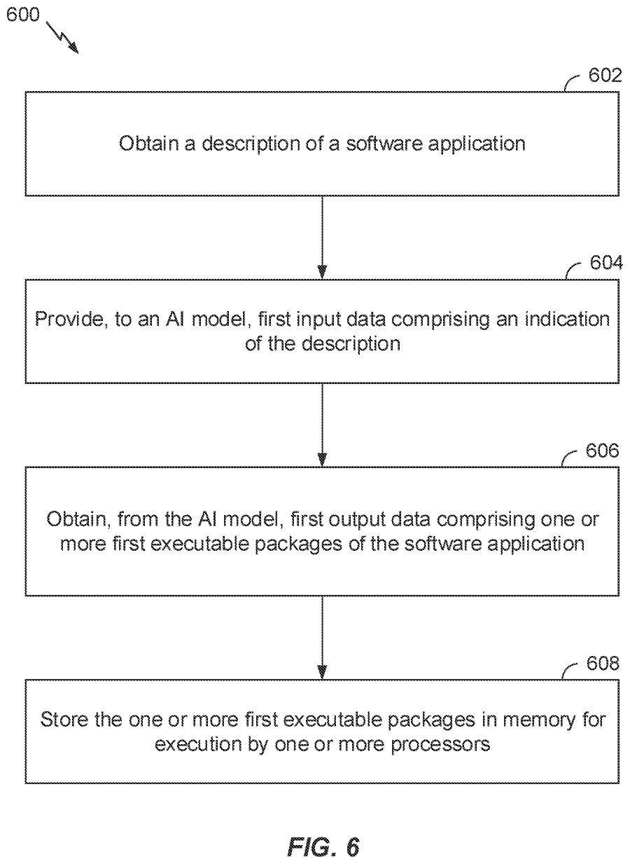

FIG. 6 depicts example operations 600 of AI-based software application generation. The operations 600 may be performed by a processing system, such as the application generation host 102.

The operations 600 may begin at 602, where the system obtains a description of a software application. In certain aspects, the description comprises a text description of the software application, an audio description of the software application, a video description of the software application, a visual illustration of the software application, or any combination thereof. The description may include an indication of one or more functionalities of the software application; an indication of an appearance of the software application; an indication of one or more operating platforms in which the software application is executed; an indication of one or more end users of the software application; or any combination thereof.

At block 604, the system may provide, to an AI model, first input data comprising an indication of the description. The AI model may be or include the AI model 110, 218, 222 of FIGS. 1 and 2 and/or the neural network 400 of FIG. 4. In certain aspects, the AI model comprises a generative AI model. The AI model may be trained to generate a complete software application that is executable by the one or more processors, for example, as described herein with respect to FIG. 5. The system may train the AI model using training data, wherein the training data comprises a plurality of training descriptions of sample applications and a plurality of executable packages corresponding to the training descriptions

At block 606, the system may obtain, from the AI model, first output data comprising one or more first executable packages of the software application. To obtain the output data, the system may generate the output data using a software development kit that is accessible to the AI model. In certain aspects, the one or more first executable packages comprises one or more instructions that, when executed by the one or more processors, cause the one or more processors to perform one or more actions of the software application in accordance with the description.

At block 608, the system may store the one or more first executable packages in memory for execution by one or more processors.

In certain aspects, the system may determine that the one or more first executable packages satisfy one or more criteria, for example, as described herein with respect to FIG. 2.

In certain aspects, the system may transfer the one or more first executable packages to a computing device (e.g., the computing device 112) in response to determining that the one or more first executable packages satisfy the one or more criteria.

In certain aspects, the system may obtain feedback on the software application. The system may provide, to the AI model, second input data comprising an indication of the feedback. The system may obtain, from the AI model, second output data comprising one or more second executable packages of the software application, wherein the one or more second executable packages comprises one or more instructions that, when executed by the one or more processors, cause the one or more processors to perform one or more actions of the software application in accordance with the feedback.

In certain aspects, the system may transfer the one or more first executable packages to a portable computing device, wherein the software application comprises a mobile application.

### Example Software Application Generation Host

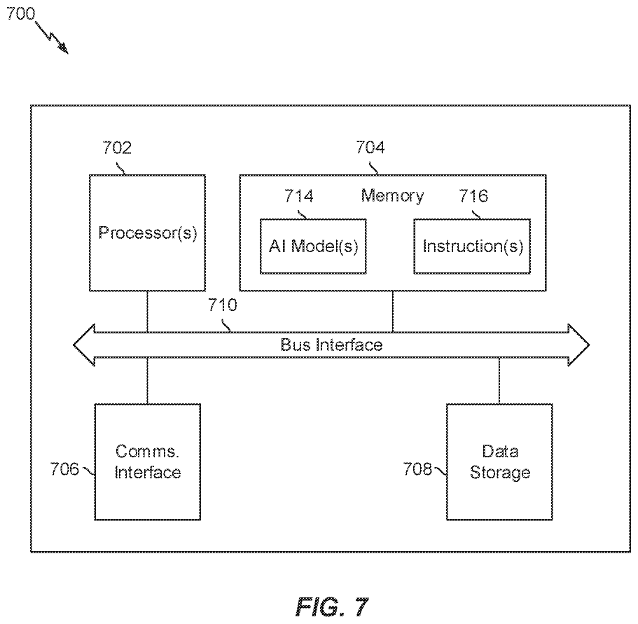

FIG. 7 depicts an example of a processing system 700 that is configured to perform the operations described herein. In some aspects, the processing system 700 may be an example of an application generation host, such as the application generation host 102 of FIG. 1 and/or the AI host 302 of FIG. 3. One or more of the functionalities and/or components described herein may be provided by the processing system 700.

As shown, the processing system 700 includes one or more processors 702 (hereinafter “the processor 702”), one or more memories 704 (hereinafter “the memory 704”), one or more communications interfaces 706 (hereinafter “the communications interface 706”), a data storage component 708, and a bus interface 710. The bus interface 710 may facilitate communication among the components of the processing system 700.

The memory 704 may be configured as volatile and/or nonvolatile memory and as such, may include random access memory (including static RAM (SRAM), dynamic RAM (DRAM), and/or other types of RAM), flash memory, ROM, secure digital (SD) memory, registers, compact discs (CD), digital versatile discs (DVD) (whether local or cloud-based), and/or other types of non-transitory processor-readable medium. The memory 704 may reside within the processing system 700 and/or a device that is external to the processing system 700.

The memory 704 may store one or more AI model(s) 714 and processor-executable instructions 716, each of which may be embodied as a computer program, firmware, and so forth. The AI models 714 may be or include any of the AI models described herein with respect to AI- based software application generation (for example, the AI model(s) 110, 218, 222 of FIGS. 1 and 2 and/or the neural network 400 of FIG. 4). The processor 702 may access the AI models 714 and the instructions 716 stored on the memory 704. The instructions 716 may include logic or algorithm(s) that execute any of the operations described herein, such as the operations 600 of FIG. 6. In certain aspects, the instructions 716 may include logic or algorithm(s) implemented via a field-programmable gate array (FPGA) configuration, an application-specific integrated circuit (ASIC), or equivalents. Accordingly, the operations described herein may be implemented in any computer programming language, as programmed hardware elements (e.g., programmable logic), or as a combination of hardware and software components. The processor 702 along with the memory 704 may operate as a controller for the processing system 700. In some cases, the instructions 716 may include an operating system and/or other software for managing components of the processing system 700.

The processor 702 may include any processing component operable to obtain and execute the AI models 714 and/or the instructions 716 from a processor-readable medium (such as the data storage component 708 and/or the memory 704). Accordingly, the processor 702 may be or include one or more of: a microcontroller, a microprocessor, an AI processor, a digital signal processor (DSP), a central processing unit (CPU), a graphics processing unit (GPU), an FPGA, an ASIC, a system on chip (SoC), a system in package (SiP), an integrated circuit, a microchip, a computer, or any other computing device.

The communications interface 706 may be configured to communicate with one or more other devices (e.g., the computing device 112 of FIG. 1). In some cases, the communications interface 706 may be or include a network interface controller (e.g., an Ethernet controller or fiber optic transceiver) and/or a wireless communications interface (e.g., a radio frequency transceiver) configured to communicate with one or more other devices, for example, in a data network. In certain cases, the communications interface 706 may be or include an input/output interface (e.g., a universal serial bus) for communicating with auxiliary hardware.

In addition to the examples described above, many examples of specific combinations are within the scope of the disclosure, some of which are detailed below:

Aspect 1: A method, comprising: obtaining a description of a software application; providing, to an artificial intelligence (AI) model, first input data comprising an indication of the description; obtaining, from the AI model, first output data comprising one or more first executable packages of the software application; and storing the one or more first executable packages in memory for execution by one or more processors.

Aspect 2: The method of Aspect 1, wherein: the description comprises a text description of the software application, an audio description of the software application, a video description of the software application, a visual illustration of the software application, or any combination thereof; the one or more first executable packages comprises one or more instructions that, when executed by the one or more processors, cause the one or more processors to perform one or more actions of the software application in accordance with the description; and the AI model comprises a generative AI model.

Aspect 3: The method of Aspect 1 or 2, wherein the description comprises: an indication of one or more functionalities of the software application; an indication of an appearance of the software application; an indication of one or more operating platforms in which the software application is executed; an indication of one or more end users of the software application; or any combination thereof.

Aspect 4: The method according to any of Aspects 1-3, wherein the AI model is trained to generate a complete software application that is executable by the one or more processors.

Aspect 5: The method according to any of Aspects 1-4, wherein obtaining the output data comprises generating the output data using a software development kit that is accessible to the AI model.

Aspect 6: The method according to any of Aspects 1-5, further comprising training the AI model using training data, wherein the training data comprises a plurality of training descriptions of sample applications and a plurality of executable packages corresponding to the training descriptions.

Aspect 7: The method according to any of Aspects 1-6, further comprising determining that the one or more first executable packages satisfy one or more criteria.

Aspect 8: The method of Aspect 7, further comprising transferring the one or more first executable packages to a computing device in response to determining that the one or more first executable packages satisfy the one or more criteria.

Aspect 9: The method according to any of Aspects 1-8, further comprising: obtaining feedback on the software application; providing, to the AI model, second input data comprising an indication of the feedback; obtaining, from the AI model, second output data comprising one or more second executable packages of the software application, wherein the one or more second executable packages comprises one or more instructions that, when executed by the one or more processors, cause the one or more processors to perform one or more actions of the software application in accordance with the feedback.

Aspect 10: The method according to any of Aspects 1-9, further comprising transferring the one or more first executable packages to a portable computing device, wherein the software application comprises a mobile application.

Aspect 11: A system, comprising: one or more memories; and one or more processors coupled to the one or more memories, the one or more processors being configured to cause the system to: obtain a description of a software application; provide, to an artificial intelligence (AI) model, first input data comprising an indication of the description; obtain, from the AI model, first output data comprising one or more first executable packages of the software application; and store the one or more first executable packages in the one or more memories for execution by at least one processor.

Aspect 12: The system of Aspect 11, wherein: the description comprises a text description of the software application, an audio description of the software application, a video description of the software application, a visual illustration of the software application, or any combination thereof; the one or more first executable packages comprises one or more instructions that, when executed by the at least one processor, cause the at least one processor to perform one or more actions of the software application in accordance with the description; and the AI model comprises a generative AI model.

Aspect 13: The system of Aspect 11 or 12, wherein the description comprises: an indication of one or more functionalities of the software application; an indication of an appearance of the software application; an indication of one or more operating platforms in which the software application is executed; an indication of one or more end users of the software application; or any combination thereof.

Aspect 14: The system according to any of Aspects 11-13, wherein the AI model is trained to generate a complete software application that is executable by the at least one processor.

Aspect 15: The system according to any of Aspects 11-14, wherein to obtain the output data, the one or more processors are configured to cause the system to generate the output data using a software development kit that is accessible to the AI model.

Aspect 16: The system according to any of Aspects 11-15, wherein the one or more processors are configured to cause the system to train the AI model using training data, wherein the training data comprises a plurality of training descriptions of sample applications and a plurality of executable packages corresponding to the training descriptions.

Aspect 17: The system according to any of Aspects 11-16, wherein the one or more processors are configured to cause the system to determine that the one or more first executable packages satisfy one or more criteria.

Aspect 18: The system of Aspect 17, wherein the one or more processors are configured to cause the system to transfer the one or more first executable packages to a computing device in response to determining that the one or more first executable packages satisfy the one or more criteria.

Aspect 19: The system according to any of Aspects 11-18, wherein the one or more processors are configured to cause the system to: obtain feedback on the software application; provide, to the AI model, second input data comprising an indication of the feedback; obtain, from the AI model, second output data comprising one or more second executable packages of the software application, wherein the one or more second executable packages comprises one or more instructions that, when executed by the at least one processor, cause the at least one processor to perform one or more actions of the software application in accordance with the feedback.

Aspect 20: The system according to any of Aspects 11-19, wherein the one or more processors are configured to cause the system to transfer the one or more first executable packages to a portable computing device, wherein the software application comprises a mobile application.

Aspect 21: A system, comprising: means for obtaining a description of a software application; means for providing, to an artificial intelligence (AI) model, first input data comprising an indication of the description; means for obtaining, from the AI model, first output data comprising one or more first executable packages of the software application; and means for storing the one or more first executable packages in memory for execution by one or more processors.

Aspect 22: A non-transitory computer-readable medium having instructions stored thereon for: obtaining a description of a software application; providing, to an artificial intelligence (AI) model, first input data comprising an indication of the description; obtaining, from the generative AI model, first output data comprising one or more first executable packages of the software application; and storing the one or more first executable packages in memory for execution by one or more processors.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method, comprising:
obtaining a description of a software application;
providing, to an artificial intelligence (AI) model, first input data comprising an indication of the description;
obtaining, from the AI model, first output data comprising one or more first executable packages of the software application; and
storing the one or more first executable packages in memory for execution by one or more processors.

2. The method of claim 1, wherein:
the description comprises a text description of the software application, an audio description of the software application, a video description of the software application, a visual illustration of the software application, or any combination thereof;
the one or more first executable packages comprises one or more instructions that, when executed by the one or more processors, cause the one or more processors to perform one or more actions of the software application in accordance with the description; and
the AI model comprises a generative AI model.

3. The method of claim 1, wherein the description comprises:
an indication of one or more functionalities of the software application;
an indication of an appearance of the software application;
an indication of one or more operating platforms in which the software application is executed;
an indication of one or more end users of the software application; or
any combination thereof.

4. The method of claim 1, wherein the AI model is trained to generate a complete software application that is executable by the one or more processors.

5. The method of claim 1, wherein obtaining the output data comprises generating the output data using a software development kit that is accessible to the AI model.

6. The method of claim 1, further comprising training the AI model using training data, wherein the training data comprises a plurality of training descriptions of sample applications and a plurality of executable packages corresponding to the training descriptions.

7. The method of claim 1, further comprising determining that the one or more first executable packages satisfy one or more criteria.

8. The method of claim 7, further comprising transferring the one or more first executable packages to a computing device in response to determining that the one or more first executable packages satisfy the one or more criteria.

9. The method of claim 1, further comprising:
obtaining feedback on the software application;
providing, to the AI model, second input data comprising an indication of the feedback;
obtaining, from the AI model, second output data comprising one or more second executable packages of the software application, wherein the one or more second executable packages comprises one or more instructions that, when executed by the one or more processors, cause the one or more processors to perform one or more actions of the software application in accordance with the feedback.

10. The method of claim 1, further comprising transferring the one or more first executable packages to a portable computing device, wherein the software application comprises a mobile application.

11. A system, comprising:
one or more memories; and
one or more processors coupled to the one or more memories, the one or more processors being configured to cause the system to:
obtain a description of a software application;
provide, to an artificial intelligence (AI) model, first input data comprising an indication of the description;
obtain, from the AI model, first output data comprising one or more first executable packages of the software application; and
store the one or more first executable packages in the one or more memories for execution by at least one processor.

12. The system of claim 11, wherein:
the description comprises a text description of the software application, an audio description of the software application, a video description of the software application, a visual illustration of the software application, or any combination thereof;
the one or more first executable packages comprises one or more instructions that, when executed by the at least one processor, cause the at least one processor to perform one or more actions of the software application in accordance with the description; and
the AI model comprises a generative AI model.

13. The system of claim 11, wherein the description comprises:
an indication of one or more functionalities of the software application;
an indication of an appearance of the software application;
an indication of one or more operating platforms in which the software application is executed;
an indication of one or more end users of the software application; or
any combination thereof.

14. The system of claim 11, wherein the AI model is trained to generate a complete software application that is executable by the at least one processor.

15. The system of claim 11, wherein to obtain the output data, the one or more processors are configured to cause the system to generate the output data using a software development kit that is accessible to the AI model.

16. The system of claim 11, wherein the one or more processors are configured to cause the system to train the AI model using training data, wherein the training data comprises a plurality of training descriptions of sample applications and a plurality of executable packages corresponding to the training descriptions.

17. The system of claim 11, wherein the one or more processors are configured to cause the system to determine that the one or more first executable packages satisfy one or more criteria.

18. The system of claim 17, wherein the one or more processors are configured to cause the system to transfer the one or more executable packages to a computing device in response to determining that the one or more first executable packages satisfy the one or more criteria.

19. The system of claim 11, wherein the one or more processors are configured to cause the system to:
obtain feedback on the software application;
provide, to the AI model, second input data comprising an indication of the feedback;
obtain, from the AI model, second output data comprising one or more second executable packages of the software application, wherein the one or more second executable packages comprises one or more instructions that, when executed by the at least one processor, cause the at least one processor to perform one or more actions of the software application in accordance with the feedback.

20. The system of claim 11, wherein the one or more processors are configured to cause the system to transfer the one or more first executable packages to a portable computing device, wherein the software application comprises a mobile application.
